(19) United States
(12) Patent Application Publication
(10) Pub. No.: US 2017/0004087 A1
(43) Pub. Date: Jan. 5, 2017

(54) ADAPTIVE CACHE MANAGEMENT METHOD ACCORDING TO ACCESS CHARACTERISTICS OF USER APPLICATION IN DISTRIBUTED ENVIRONMENT

(71) Applicant: Korea Electronics Technology Institute, Seongnam-si (KR)

(72) Inventors: Jae Hoon An, Incheon (KR); Young Hwan Kim, Yongin-si (KR)

(21) Appl. No.: 15/188,649

(22) Filed: Jun. 21, 2016

(30) Foreign Application Priority Data
Jun. 30, 2015 (KR) 10-2015-0092738

(51) Int. Cl. G06F 12/08

(52) U.S. Cl. CPC G06F 12/0862; G06F 12/0877; G06F 2212/1021; G06F 2212/1041; G06F 2212/281; G06F 2212/6026; G06F 2212/6024

(57) ABSTRACT

An adaptive cache management method according to access characteristic of a user application in a distributed environment is provided. The adaptive cache management method includes: determining an access pattern of a user application; and determining a cache write policy based on the access pattern. Accordingly, a delay in speed which may occur in an application can be minimized by efficiently using resources established in a distributed environment and using an adaptive policy.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on Jun. 30, 2015, and assigned Serial No. 10-2015-0092738, the entire disclosure of which is hereby incorporated by reference.

### BACKGROUND OF THE INVENTION

Field of the Invention

The present invention relates generally to a cache management method, and more particularly, to an adaptive cache management method in a distributed environment.

Description of the Related Art

An existing cache device structure utilizing a Solid State Drive (SSD) is designed to operate an SSD device with a cache memory to enhance a read/write (R/W) speed of a hard disk and guarantee price competitiveness.

However, since all of data is ultimately accessed through the hard disk, the cache device is influenced by the speed of the hard disk.

In addition, when the cache is saturated due to increased processing of various user data requests which may occur in a distributed environment, the cache operation for accessing necessary data may cause a delay in processing input and output.

Accordingly, there is a demand for a method for preventing an input/output delay caused by cache saturation which occurs due to unnecessary data, and providing an input/output speed appropriate to an application using necessary data.

### SUMMARY OF THE INVENTION

To address the above-discussed deficiencies of the prior art, it is a primary aspect of the present invention to provide a cache-adaptive cache management method and system, which can determine a cache write policy appropriate to a cache device which is applied to provide a fast driving speed to various user applications in a distributed environment, can use the cache device more efficiently by increasing a hit ratio of data blocks necessary for driving, and can increase driving efficiency of the user applications.

According to one aspect of the present invention, an adaptive cache management method includes: determining an access pattern of a user application; and determining a cache write policy based on the access pattern.

The determining the cache write policy may include, when the access pattern indicates that recently referred data is referred to again, determining a cache write policy of storing data recorded on a cache in a storage medium afterward.

The determining the cache write policy may include, when the access pattern indicates that referred data is referred to again after a predetermined interval, determining a cache write policy of immediately storing data recorded on a cache in a storage medium.

The determining the cache write policy may include, when the access pattern indicates that referred data is not referred to again, determining a cache write policy of immediately storing data in a storage medium without recording on a cache.

The adaptive cache management method may further include: selecting data which is most likely to be referred to based on the access pattern; and loading the selected data into a cache.

According to another aspect of the present invention, a storage server includes: a cache; and a processor configured to determine an access pattern of a user application and determine a cache write policy based on the access pattern.

According to exemplary embodiments of the present invention as described above, an average rate of use of available resources in driving a user application in a distributed environment can be increased to the maximum.

In addition, a delay in speed which may occur in an application can be minimized by efficiently using resources established in a distributed environment and using an adaptive policy.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view to illustrate a method for determining an adaptive cache write policy based on access characteristics of a user application;

FIG. 2 is a flowchart to illustrate an adaptive cache management method based on access characteristics of a user application; and

FIG. 3 is a block diagram of a storage server according to an exemplary embodiment of the present invention.

### DETAILED DESCRIPTION OF THE PREFERRED EMBODIMENT

Reference will now be made in detail to the embodiment of the present general inventive concept, examples of which are illustrated in the accompanying drawings, wherein like reference numerals refer to the like elements throughout. The embodiment is described below in order to explain the present general inventive concept by referring to the drawings.

Exemplary embodiments of the present invention provide an adaptive cache management method according to access characteristics of a user application in a distributed environment, for providing a fast driving speed to various user applications in the distributed environment.

To achieve this, exemplary embodiments of the present invention determine/change an optimal cache write policy, adaptively, so as to increase operation efficiency of applications according to access request characteristics of various applications in the distributed environment.

In addition, exemplary embodiments of the present invention increase a hit ratio of data blocks by pre-loading necessary blocks according to access characteristics, so that available resources of a cache device can be used more efficiently and actively.

Hereinafter, a method for determining an adaptive cache write policy and a method for pre-loading data blocks according to access characteristics of a user application will be explained in detail.

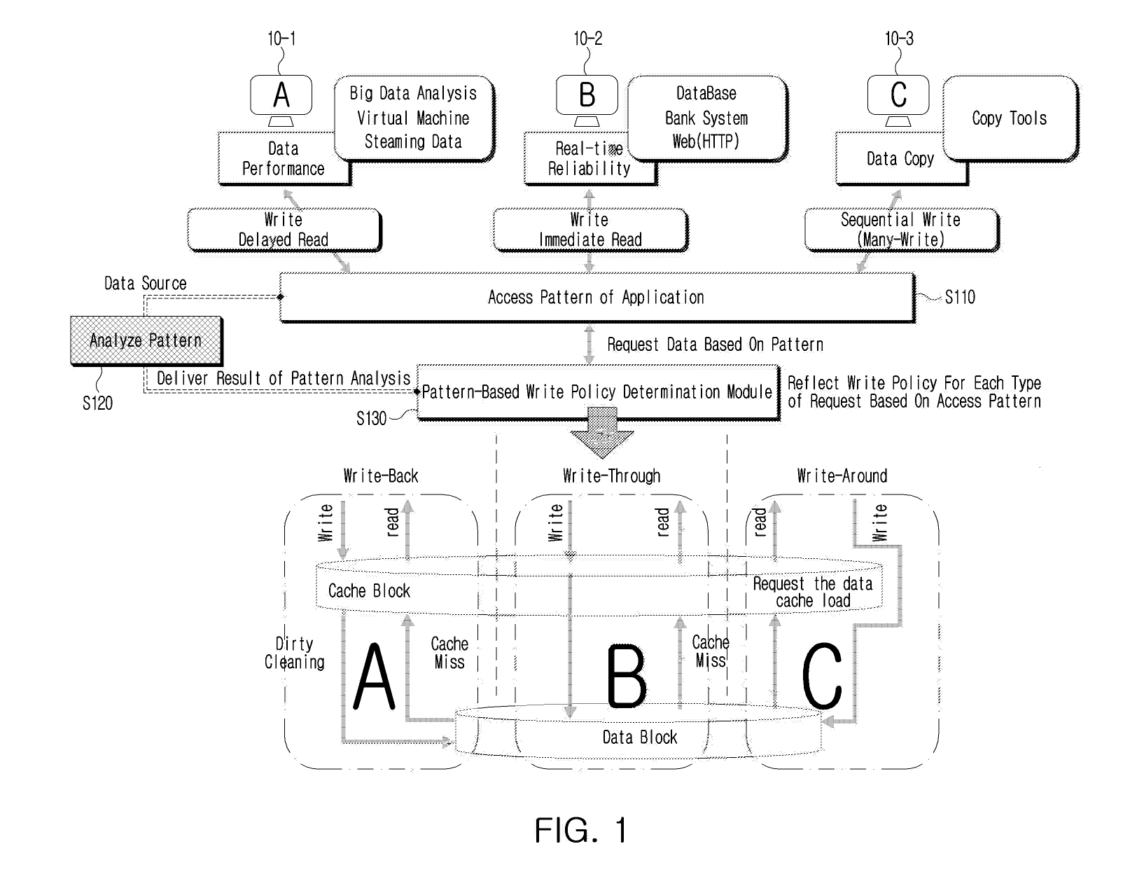

FIG. 1 is a view to illustrate a method for determining an adaptive cache write policy based on access characteristics of a user application.

As shown in FIG. 1, an access pattern of a user application is collected (S110).

In FIG. 1, it is assumed that a user application-A 10-1 is an application for analyzing big data, a user application-B 10-2 is an application for managing a database, and a user application-C 10-3 is an application for copying data.

The access pattern of the user application is determined by analyzing the result of the collecting in step S110 (S120).

In step S120, the access pattern of the user application-A 10-1 for analyzing the big data is determined as an access pattern (Write & Delayed Read) indicting that a recently referred data block is referred to again, the access pattern of the user application-B 10-2 for managing the database is determined as an access pattern (Write & Immediate Read) indicating that a referred data block is referred to again after a predetermined interval, and the access pattern of the user application-C 10-3 for copying the data is determined as an access pattern (Sequential Write) indicating that a referred data block is not referred to again.

A cache write policy for the user application is determined based on the determined access pattern (S130).

In step S130, for the user application-A 10-1 for analyzing the big data, which is determined as having the access pattern “Write & Delayed Read,” a cache write policy (Write-Back) of storing data recorded on a cache in a storage medium afterward is determined.

In addition, for the user application-B 10-2 for managing the database, which is determined as having the access pattern “Write & Immediate Read,” a cache write policy (Write-Through) of immediately storing data recorded on a cache in a storage medium is determined.

In addition, for the user application-C 10-3 for copying the data, which is determined as having the access pattern “Sequential Write,” a cache write policy (Write-Around) of immediately storing data on a storage medium without recording on a cache is determined.

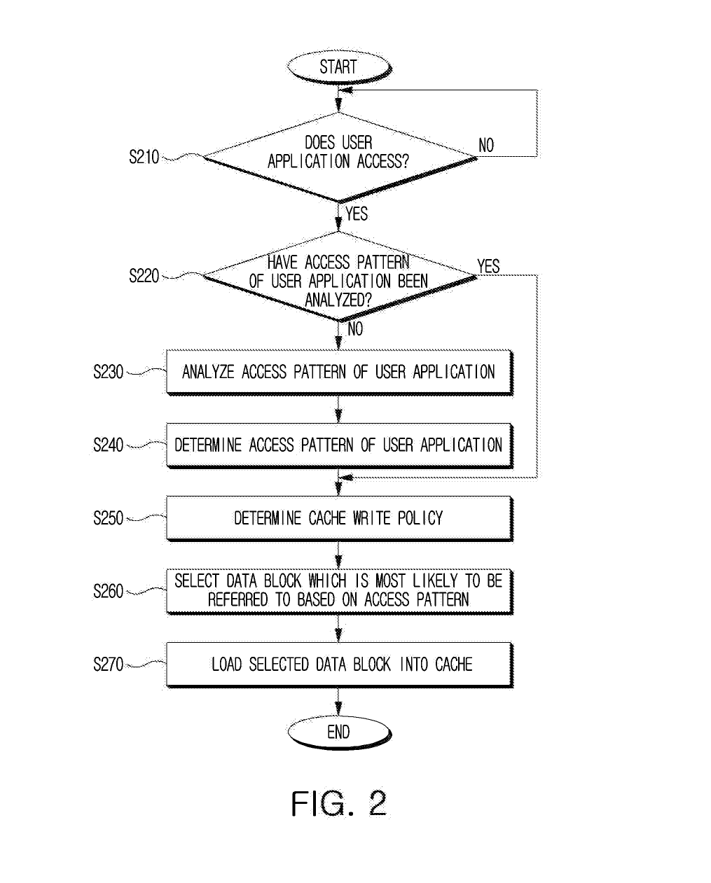

FIG. 2 is a flowchart to illustrate an adaptive cache management method based on access characteristics of a user application.

As shown in FIG. 2, when a user application accesses a cache/HDD (S210-Y), it is determined whether the access pattern of the user application has been analyzed or not (S220).

The user application includes an application for analyzing big data, an application for managing a database, an application for copying data, and applications for performing other functions.

When it is determined that the access pattern of the user application has not been analyzed (S220-N) in step 5220, the access pattern of the user application is determined by analyzing (S230, S240).

For example, the access pattern of the user application for analyzing the big data is determined as “Write & Delayed Read,” the access pattern of the user application for managing the database is determined as “Write & Immediate Read,” and the access pattern of the user application for copying the data is determined as “Sequential Write.”

Thereafter, based on the access pattern determined in step S240, a cache write policy for the user application is determined (S250).

For example, when the access pattern is “Write & Delayed Read,” the cache write policy is determined as “Write-Back,” when the access pattern is “Write & Immediate Read,” the cache write policy is determined as “Write-Through,” and, when the access pattern is “Sequential Write,” the cache write policy is determined as “Write-Around.”

On the other hand, when it is determined that the access pattern of the user application has been analyzed (S220-Y), steps S230 and S240 are omitted and step S250 is directly performed.

Next, a data block which is most likely to be referred to is selected based on the access pattern (S260), and the selected data block is loaded into the cache (S270).

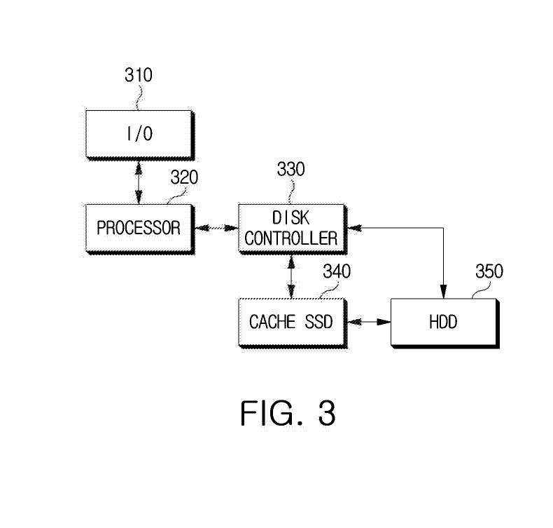

FIG. 3 is a block diagram of a storage server according to an exemplary embodiment of the present invention. As shown in FIG. 3, the storage server according to an exemplary embodiment of the present invention includes an I/O 310, a processor 320, a disk controller 330, an SSD cache 340, and a Hard Disk Drive (HDD) 350.

The I/O 310 is connected to clients through a network to serve as an interface to allow user applications to access the storage server.

The processor 320 determines an access pattern of a user application which accesses through the I/O 310 by analyzing, and determines a cache write policy for the user application based on the determined access pattern.

In addition, the processor 320 selects a data block which is most likely to be referred to based on the determined access pattern.

The disk controller 330 controls the SSD cache 340 and the HDD 350 according to the cache write policy determined by the processor 320. In addition, the disk controller 330 loads the data block selected by the processor 320 into the SSD cache 340.

The adaptive cache management method according to access characteristics of a user application in a distributed environment according to exemplary embodiments has been described up to now.

The exemplary embodiments of the present invention provides a structure for preventing an input/output delay caused by cache saturation which occurs due to unnecessary data, providing an input/output speed appropriate to an application using necessary data, and efficiently operating.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An adaptive cache management method comprising:
determining an access pattern of a user application; and
determining a cache write policy based on the access pattern.

2. The adaptive cache management method of claim 1, wherein the determining the cache write policy comprises, when the access pattern indicates that recently referred data is referred to again, determining a cache write policy of storing data recorded on a cache in a storage medium afterward.

3. The adaptive cache management method of claim 1, wherein the determining the cache write policy comprises, when the access pattern indicates that referred data is referred to again after a predetermined interval, determining a cache write policy of immediately storing data recorded on a cache in a storage medium.

4. The adaptive cache management method of claim 1, wherein the determining the cache write policy comprises, when the access pattern indicates that referred data is not referred to again, determining a cache write policy of immediately storing data in a storage medium without recording on a cache.

5. The adaptive cache management method of claim 1, further comprising:
selecting data which is most likely to be referred to based on the access pattern; and
loading the selected data into a cache.

6. A storage server comprising:
a cache; and
a processor configured to determine an access pattern of a user application and determine a cache write policy based on the access pattern.
